(19) United States
(12) Patent Application Publication
(10) Pub. No.: US 2020/0359658 A1
(43) Pub. Date: Nov. 19, 2020

(54) BEVERAGE

(71) Applicants: ASAHI GROUP HOLDINGS, LTD., Tokyo (JP); ASAHI SOFT DRINKS CO., LTD., Tokyo (JP)

(72) Inventor: Momoko MUNE, Ibaraki (JP)

(73) Assignees: ASAHI GROUP HOLDINGS, LTD., Tokyo (JP); ASAHI SOFT DRINKS CO., LTD., Tokyo (JP)

(21) Appl. No.: 16/629,638

(22) PCT Filed: Jun. 12, 2018
(86) PCT No.: PCT/JP2018/022366

§ 371 Date: Jan. 9, 2020

(30) Foreign Application Priority Data
Aug. 9, 2017 (JP) 2017-153947

(51) Int. Cl. A23L 2/60; A23L 27/30

(52) U.S. Cl. CPC A23L 2/60; A23V 2002/00; A23L 27/34

(57) ABSTRACT

To provide a novel technique whereby a lingering sticky feeling in the aftertaste of a beverage containing a high sweetness sweetener can be reduced. A beverage containing a high sweetness sweetener and a sugar alcohol, wherein the content of the sugar alcohol is 0.1-2.0 mass % relative to the beverage and the penetrance of the sugar alcohol contained in the beverage is less than 99.

### TECHNICAL FIELD

The present invention relates to a beverage, specifically to a beverage containing a high-intensity sweetener.

### BACKGROUND ART

Conventionally, sugar (sucrose) has been widely used as a sweetener in refreshing beverages. Meanwhile, the sucrose consumption has declined because of current health consciousness and low calorie orientation, and high-intensity sweeteners have been employed instead of sucrose. Such sweeteners have more intensive sweetness than that of sucrose and can impart sweetness in a smaller amount to be used. Examples of beverages in which a high-intensity sweetener is used include beverages of Patent Literatures 1 and 2.

Beverages containing a high-intensity sweetener, however, are also known to have less preferred properties from the viewpoint of palatability of beverages, for example, persistent sweetness (existence of a persistent sweetness feeling) and the like. For this reason, methods for suppressing persistence of sweetness derived from a high-intensity sweetener have been proposed (e.g., see Patent Literatures 3 and 4).

### CITATION LIST

### Patent Literature

Patent Literature 1: JP2016-168021
Patent Literature 2: JP2002-065156
Patent Literature 3: JP2012-130336
Patent Literature 4: JP2015-073501

### SUMMARY OF INVENTION

### Technical Problem

An object of the present invention is to provide a novel technique capable of suppressing a sticky feeling in an aftertaste which is felt when a beverage containing a high-intensity sweetener is swallowed.

### Solution to Problem

When a beverage containing a high-intensity sweetener is swallowed, there occurs a feeling that sweetness clings to the inside of the mouth (a sticky feeling), and the present inventor has attempted to suppress the sticky feeling. Then, the present inventor has intensively studied to have found that a sticky feeling derived from a high-intensity sweetener can be suppressed by allowing a beverage to contain a sugar alcohol having a predetermined degree of osmosis at a predetermined ratio in a beverage, having completed the present invention.

The gist of the present invention is as follows.
[1] A beverage comprising:

a high-intensity sweetener; and

a sugar alcohol, wherein

the content of the sugar alcohol is 0.1 to 2.0% by mass per beverage, and

the degree of osmosis of the sugar alcohol contained in the beverage is less than 99.
[2] The beverage according to [1], wherein

the beverage comprises sucralose and acesulfame potassium as the high-intensity sweetener, and

a relation: A>B is satisfied, wherein A is the degree of sweetness of sucralose contained in the beverage, and B is the degree of sweetness of acesulfame potassium contained in the beverage.
[3] The beverage according to [1] or [2], wherein the degree of osmosis of the sugar alcohol is 70 or more and less than 99.
[4] The beverage according to any one of [1] to [3], wherein

the beverage comprises sucralose and acesulfame potassium as the high-intensity sweetener,

the content of sucralose is 0.005 to 0.02% by mass per beverage,

the content of acesulfame potassium is 0.001 to 0.01% by mass per beverage, and

the content ratio between sucralose and acesulfame potassium is 2:1 to 5:1.
[5] A method of suppressing a sticky feeling in an aftertaste, comprising

adding a sugar alcohol in preparation of a beverage containing a high-intensity sweetener such that the content of the sugar alcohol in the beverage is 0.1 to 2.0% by mass, wherein

the degree of osmosis of the sugar alcohol contained in the beverage is less than 99.

### Advantageous Effect of Invention

According to the present invention, it is possible to provide a novel technique capable of suppressing a sticky feeling in an aftertaste which is felt when a beverage containing a high-intensity sweetener is swallowed.

### DESCRIPTION OF EMBODIMENT

Hereinafter, one embodiment of the present invention will be described in detail.

The present embodiment relates to a beverage containing a high-intensity sweetener, and the beverage contains a sugar alcohol in addition to the high-intensity sweetener. In the present embodiment, the content of the sugar alcohol is 0.1 to 2.0% by mass per beverage, and the degree of osmosis of the sugar alcohol contained in the beverage is less than 99.

The high-intensity sweetener herein refers to a natural sweetener or synthetic sweetener having more intense sweetness (e.g., several hundred times to several thousand times) than that of sucrose.

Examples of the high-intensity sweetener include sucralose, aspartame, acesulfame potassium, saccharin, sodium saccharin, stevia extract, rebaudioside A, neotame, alitame, monatin, thaumatin, liquorice extract (glycyrrhizin), luo han guo extract (mogroside), and sweet hydrangea extract (phyllodulcin). It is possible to allow the beverage to contain one or two or more of these, for example.

The type of high-intensity sweetener in the beverage of the present embodiment is not particularly limited, but sucralose and acesulfame potassium are preferably contained from the viewpoint of further suppressing a sticky feeling.

Additionally, from the viewpoint of suppressing bitterness in addition to suppressing a sticky feeling, in a more preferable aspect, the beverage of the present embodiment comprises sucralose and acesulfame potassium as a high-intensity sweetener, and the relation: A>B is satisfied, wherein A is the degree of sweetness of sucralose contained in the beverage, and B is the degree of sweetness of acesulfame potassium contained in the beverage.

The “degree of sweetness” of each sweetener herein means the intensity of the sweetness derived from the sweetener in the beverage and is specifically a numerical value that indicates the degree of sweetness of the beverage derived from the sweetener when the degree of sweetness of sucrose is set to 1.

The degree of sweetness can be calculated from the content of each sweetener and the value of the degree of sweetness thereof in terms of sucrose per unit on the basis of the following expression (1). In respect with the degree of sweetness in terms of sucrose per unit, the degree of sweetness of sucralose is 600 times that of sucrose, and the degree of sweetness of acesulfame potassium is 200 times that of sucrose. For example, when the content of sucralose is 0.017% by mass per beverage, the degree of sweetness of sucralose in the beverage is 10.2.

Additionally, the total value of the degrees of sweetness of each of sweeteners contained in the beverage herein is taken as the degree of sweetness of the beverage (value in terms of sucrose).

(Content of sweetener (% by mass))×(Value of degree of sweetness in terms of sucrose per unit amount formulated with respect to the sweetener contained in the beverage) Expression (1):

In the beverage of the present embodiment, the content of the high-intensity sweetener is not particularly limited and can be appropriately set by those skilled in the art. From the viewpoint that a sticky feeling can be further suppressed, the lower limit of the content of acesulfame potassium, for example, is preferably 0.001% by mass, more preferably 0.002% by mass, per beverage. The upper limit thereof is preferably 0.04% by mass, more preferably 0.02% by mass, even more preferably 0.01% by mass. When sucralose is used, the lower limit of the content of sucralose is preferably 0.002% by mass, more preferably 0.005% by mass, even more preferably 0.008% by mass, per beverage. The upper limit thereof is preferably 0.02% by mass.

From the viewpoint of suppressing bitterness in addition to suppressing a sticky feeling, in a more preferable aspect, the beverage contains sucralose and acesulfame potassium as the high-intensity sweetener, the content of sucralose is 0.005 to 0.02% by mass per beverage, the content of acesulfame potassium is 0.001 to 0.01% by mass per beverage, and the content ratio between sucralose and acesulfame potassium is 2:1 to 5:1 in a mass ratio.

As mentioned above, the beverage of the present embodiment contains a sugar alcohol in addition to the high-intensity sweetener, and the content thereof is 0.1 to 2.0% by mass per beverage. From the viewpoint of further enhancing a refreshing feeling, the content is preferably 0.3 to 1.0% by mass.

In the present embodiment, the degree of osmosis of the sugar alcohol contained in the beverage is less than 99, and from the viewpoint that a sticky feeling can be further suppressed, the degree of osmosis is preferably 70 or more and less than 99, more preferably 85 or more and less than 99.

The degree of osmosis herein refers to the osmotic pressure of the sugar alcohol when the osmotic pressure of sucrose is set to 100.

It is possible to allow a sugar alcohol having a degree of osmosis of less than 99 to be contained in the beverage of the present embodiment by adding the sugar alcohol as a raw material.

Examples of sugar alcohols having a degree of osmosis of less than 99 include reduced sugar syrups and reduced maltose syrups having a degree of osmosis of less than 99. The reduced sugar syrup is a composition comprising a plurality of sugar alcohols, which can be obtained by hydrolyzing (reducing) sugar syrup. Designations therefor such as reduced starch hydrolyzate, saccharified reduced starch, reduced oligosaccharide, and the like may be used. The sugar syrup can be obtained by hydrolyzing starch using an acid, enzyme, or the like. A sugar syrup containing a reduced maltose (maltitol) of 75% or more is referred to as a reduced maltose syrup.

Reduced sugar syrups and reduced maltose syrups having a degree of osmosis of less than 99 are commercially available, and examples thereof can include ESWEE 20, ESWEE 30, ESWEE 57, ESWEE 100, and Malbit (manufactured by B Food Science Co., Ltd.). The beverage of the present embodiment may comprise, for example, one or two or more of these commercially available sugar alcohols having a degree of osmosis of less than 99.

ESWEE and Malbit are registered trademarks of B Food Science Co., Ltd.

The osmotic pressure may be measured using any of known methods and can be measured by a freezing point depression method, for example. As a measurement apparatus, an Advance automatic osmometer, Osmometer 3250 (Advanced Instruments Inc.) can be used.

The beverage of the present embodiment may comprise other ingredients in addition to the high-intensity sweetener and sugar alcohol described above as long as the effect of the present invention can be achieved.

Examples of other ingredients that may be contained in the beverage of the present embodiment include a milk, a milk protein stabilizer, a sweetener, an acidulant, a juice, a fragrance, and a pigment.

The milk may be any milk derived from animals or vegetables. For example, an animal milk such as cow's milk, goat's milk, sheep's milk, and horse's milk, or a vegetable milk such as soy milk can be used, and cow's milk is commonly used. One of these milks can be used singly or two or more thereof can be used in combination. These milks are fermented using a microorganism such as Lactobacillus or Bifidobacteria and then used as fermented milks.

The form of the milk is not particularly limited, and examples thereof include whole fat milk, skim milk, whey, and milk protein concentrate. Milks reconstituted from a powder milk or concentrated milk also can be used. The content of a solids-not-fat (SNF) is also not particularly limited, but is preferably 0.1 to 1.2% by mass from the viewpoint of a refreshing feeling.

The milk protein stabilizer may be contained, for example, when the beverage of the present embodiment comprises the milk mentioned above. Example of the milk protein stabilizer include soybean polysaccharides.

As the soybean polysaccharide, ones known as stabilizers for milk protein can be used. Usually, it is possible to use polysaccharides extracted and purified from okara (fibrous squeezed residue), which is by-produced in a production step of a soybean product, the polysaccharides being negatively charged under an acidic condition due to the carboxyl group of galacturonic acid contained. An example of a commercially available product thereof is trade name “SM-1200” (manufactured by San-Ei Gen F. F. I., Inc.).

Examples of milk protein stabilizers other than soybean polysaccharides include HM pectin, carboxymethyl cellulose (CMC), gellan gum, guar gum, xanthan gum, and gum arabic.

Examples of the sweetener include saccharides such as sucrose, maltose, fructose, glucose, fructose glucose syrup, and oligosaccharide.

Examples of the acidulant include organic acids such as lactic acid, citric acid, malic acid, tartaric acid, acetic acid, phytic acid, gluconic acid, succinic acid, fumaric acid or salts thereof and inorganic acids such as phosphoric acid or salts thereof.

Examples of the juice include juices of citruses such as orange, lemon, and grapefruit, juices of grape, peach, apple, banana, and the like.

The beverage of the present embodiment is preferably a packaged beverage, which is filled in a container. Examples of the container include hermetically-sealed containers made of glass, plastic such as polyethylene terephthalate (PET), polyethylene, and polypropylene, paper, aluminum, or steel.

The beverage of the present embodiment can be prepared by, for example, allowing a sugar alcohol having a degree of osmosis less than 99 to be contained such that the content thereof in the beverage is 0.1 to 2.0% by mass, in production of the beverage containing a high-intensity sweetener.

Specifically, the beverage of the present embodiment can be produced by a method comprising a step of mixing a liquid raw material, a high-intensity sweetener, a sugar alcohol having a degree of osmosis of less than 99, and other ingredients to be added as required such that the content of the sugar alcohol having a degree of osmosis of less than 99 per beverage is 0.1 to 2.0% by mass. The liquid raw material may be a solution or dispersion of other ingredients mentioned above, besides water. The high-intensity sweetener and the sugar alcohol having a degree of osmosis of less than 99 may be formulated simultaneously in the liquid raw material or may be formulated separately in the liquid raw material, and the order of the formulation is also not particularly limited.

In the production method according to the present embodiment, the beverage obtained may be subjected to a sterilization treatment. When milk and the like are contained, the beverage may be subjected to a homogenization treatment.

The homogenization treatment may be performed usually using a homogenizer. Homogenization conditions are not particularly limited, but conditions of a temperature of 5 to 25° C. and a pressure of 10 to 50 Mpa are preferably used. The homogenization treatment may be performed before or after or both before and after the sterilization treatment.

The sterilization treatment can be performed by means of heat sterilization having a sterilization value equivalent to that of 10 minutes at 65° C., for example. The method for the sterilization treatment is not particularly limited, and a method such as common plate-type sterilization, tubular type sterilization, retort sterilization, batch sterilization, or autoclave sterilization can be employed. The sterilization treatment can be performed before or after or both before and after the homogenization treatment, or before or after or both before and after the packaging.

The beverage of the present embodiment may be a packaged beverage, as mentioned above. For example, packaging may be performed by, but not limited to, a method in which the beverage is hot-pack filled in a container, and then the container filled is cooled, a method in which the beverage is cooled to a temperature suitable for packaging and aseptically-filled in a container cleaned and sterilized in advance, or the like.

As mentioned above, according to the present embodiment, in a beverage comprising a high-intensity sweetener, it is possible to suppress a sticky feeling in an aftertaste when the beverage is swallowed by setting the content of the sugar alcohol to 0.1 to 2.0% by mass and allowing the beverage to contain a sugar alcohol having a degree of osmosis of less than 99.

As a result, it is possible to provide a high-intensity sweetener-containing beverage having more excellent palatability.

### EXAMPLES

Hereinafter, the present invention will be described in further detail with reference to examples, but the present invention is not limited thereto.

### [Preparation of Beverage]

The ingredients described in Tables 1 and 2 in the content described in Tables 1 and 2 (formulation ratio: % by mass) were mixed with water in an amount achieving 100% by mass as a beverage. After the mixing, a homogenization treatment was performed to prepare a preparation liquid. The preparation liquid obtained was heat sterilized, hot-pack filled in a container, and water-cooled to room temperature to thereby obtain packaged beverages of Examples and Comparative Examples.

As sugar alcohols, Malbit, ESWEE 30, ESWEE 600, and erythritol were used (all were manufactured by B Food Science Co., Ltd.). The degree of osmosis of each sugar alcohol is shown in Table 3.

A homogenization treatment was performed using a laboratory homogenizer (model 15MR, manufactured by APV Gaulin) at a treatment temperature of 20° C. and a treatment pressure of 15 MPa. As heat sterilization, sterilization at an achieved temperature of 95° C. was performed.

TABLE 1

| | Comparative | | | | | |
|---|---|---|---|---|---|---|
| | Example 1 | Example 1 | Example 2 | Example 3 | Example 4 | Example 5 |
| Sugar | 5.2 | 5.2 | 5.2 | 5.2 | 5.2 | 5.2 |
| Skim milk | 0.70 | 0.70 | 0.70 | 0.70 | 0.70 | 0.70 |
| powder | | | | | | |
| Lactic acid | 0.20 | 0.20 | 0.20 | 0.20 | 0.20 | 0.20 |
| Citric acid | 0.20 | 0.20 | 0.20 | 0.20 | 0.20 | 0.20 |
| Soybean | 0.10 | 0.10 | 0.10 | 0.10 | 0.10 | 0.10 |
| polysaccharide | | | | | | |
| Pectin | 0.10 | 0.10 | 0.10 | 0.10 | 0.10 | 0.10 |
| Trisodium | 0.16 | 0.16 | 0.16 | 0.16 | 0.16 | 0.16 |
| citrate | | | | | | |
| Sucralose | 0.017 | 0.017 | 0.017 | 0.017 | 0.017 | 0.017 |
| Acesulfame | 0.004 | 0.004 | 0.004 | 0.004 | 0.004 | 0.004 |
| potassium | | | | | | |
| Malbit | — | 0.3 | 0.5 | 1 | 1.25 | 2 |
| ESWEE 30 | — | — | — | — | — | — |
| ESWEE 600 | — | — | — | — | — | — |
| Erythritol | — | — | — | — | — | — |
| Fragrance | 0.17 | 0.17 | 0.17 | 0.17 | 0.17 | 0.17 |

(% by mass)

| | | Comparative | Comparative | Comparative | |
|---|---|---|---|---|---|
| | Example 6 | Example 2 | Example 2 | Example 4 | Example 7 |
| Sugar | 5.2 | 5.2 | 5.2 | 5.2 | 5.2 |
| Skim milk | 0.70 | 0.70 | 0.70 | 1.70 | 1.70 |
| powder | | | | | |
| Lactic acid | 0.20 | 0.20 | 0.20 | 0.20 | 0.20 |
| Citric acid | 0.20 | 0.20 | 0.20 | 0.20 | 0.20 |
| Soybean | 0.10 | 0.10 | 0.10 | 0.10 | 0.10 |
| polysaccharide | | | | | |
| Pectin | 0.10 | 0.10 | 0.10 | 0.10 | 0.10 |
| Trisodium | 0.15 | 0.15 | 0.15 | 0.15 | 0.15 |
| citrate | | | | | |
| Sucralose | 0.017 | 0.017 | 0.017 | 0.017 | 0.017 |
| Acesulfame | 0.004 | 0.004 | 0.004 | 0.004 | 0.004 |
| potassium | | | | | |
| Malbit | — | — | — | — | 0.3 |
| ESWEE 30 | 0.3 | — | — | — | — |
| ESWEE 600 | — | 0.3 | — | — | — |
| Erythritol | — | — | 0.3 | — | — |
| Fragrance | 0.17 | 0.17 | 0.17 | 0.17 | 0.17 |

(% by mass)

TABLE 2

| | Comparative | | | Comparative | Comparative |
|---|---|---|---|---|---|
| | Example 5 | Example 8 | Example 9 | Example 6 | Example 7 |
| Sugar | 5.2 | 5.2 | 5.2 | 5.2 | 5.2 |
| Skim milk powder | — | — | — | — | — |
| Lactic acid | — | — | — | — | — |
| Citric acid | 0.17 | 0.17 | 0.17 | 0.17 | 0.17 |
| Soybean polysaccharide | — | — | — | — | — |
| Pectin | — | — | — | — | — |
| Trisodium citrate | 0.13 | 0.13 | 0.13 | 0.13 | 0.13 |
| Sucralose | 0.007 | 0.007 | 0.007 | 0.007 | 0.007 |
| Acesulfame potassium | 0.002 | 0.002 | 0.002 | 0.002 | 0.002 |
| Malbit | — | 0.3 | — | — | — |
| ESWEE 30 | — | — | 0.3 | — | — |
| ESWEE 600 | — | — | — | 0.3 | — |
| Erythritol | — | — | — | — | 0.3 |
| Fragrance | — | — | — | — | — |

(% by mass)

| | Comparative | Example | Comparative | Example |
|---|---|---|---|---|
| | Example 8 | 10 | Example 9 | 11 |
| Sugar | 5.2 | 5.2 | 5.2 | 5.2 |
| Skim milk powder | 0.70 | 0.70 | 0.70 | 0.70 |
| Lactic acid | 0.10 | 0.10 | 0.10 | 0.10 |
| Citric acid | 0.13 | 0.13 | 0.13 | 0.13 |
| Soybean polysaccharide | 0.10 | 0.10 | 0.10 | 0.10 |
| Pectin | 0.10 | 0.10 | 0.10 | 0.10 |
| Trisodium citrate | 0.06 | 0.06 | 0.06 | 0.06 |
| Sucralose | 0.007 | 0.007 | 0.004 | 0.004 |
| Acesulfame potassium | 0.002 | 0.002 | 0.013 | |
| Malbit | — | 0.3 | — | 0.3 |
| ESWEE 30 | — | — | — | — |
| ESWEE 600 | — | — | — | — |
| Erythritol | | | | |
| Fragrance | 0.17 | 0.17 | 0.17 | 0.17 |

(% by mass)

TABLE 3

| | Sugar | Malbit | ESWEE 30 | ESWEE 600 | Erythritol |
|---|---|---|---|---|---|
| Penetrability | 100 | 90 | 55 | 130 | 320 |

### [Sensory Evaluation]

Sensory evaluation was performed by five panelists with respect to “refreshing feeling”, “sticky feeling”, “aftertaste”, “bitterness”, and “tastiness”.

Of these, the refreshing feeling is a feel as if the aftertaste after drinking is rapidly eliminated, refers to a feeling felt when the aftertaste after drinking including sweetness, bitterness, sourness, umami (savory taste), and a salty are disappearing, and is also called elimination of the aftertaste. The refreshing feeling was evaluated in the following five grades:

1: not present, 2: scarcely present, 3: slightly present, 4: present, 5: extremely present

The sticky feeling was evaluated in the following five grades:

1: not present, 2: scarcely present, 3: slightly present, 4: present, 5: extremely present

The aftertaste was evaluated in the following five grades:

1: bad, 2: slightly bad, 3: neutral, 4: slightly good, 5: good

The bitterness was evaluated in the following five grades:

1: not present, 2: scarcely present, 3: slightly present, 4: present, 5: extremely present

The tastiness was evaluated in the following five grades:

1: unpalatable, 2: slightly unpalatable, 3: neutral, 4: slightly tasty, 5: tasty

Evaluation points were averaged and shown in Tables 4 and 5. In comprehensive evaluation, whether the sticky feeling was suppressed and an improvement occurred in comparison with Comparative Examples 1, 4, 5, 8, or 9 was evaluated.

TABLE 4

| | Comparative | | | | | |
|---|---|---|---|---|---|---|
| | Example 1 | Example 1 | Example 2 | Example 3 | Example 4 | Example 5 |
| Malbit (% by mass) | 0 | 0.3 | 0.5 | 1 | 1.25 | 2 |
| ESWEE 30 (% by mass) | 0 | 0 | 0 | 0 | 0 | 0 |
| ESWEE 600 (% by mass) | 0 | 0 | 0 | 0 | 0 | 0 |
| Erythritol (% by mass) | 0 | 0 | 0 | 0 | 0 | 0 |
| SNF | 0.7 | 0.7 | 0.7 | 0.7 | 0.7 | 0.7 |
| Degree of sweetness | 16.3 | 16.6 | 16.7 | 17.1 | 17.3 | 17.8 |
| A: Degree of sweetness | 10.2 | | | | | |
| (sucralose) | | | | | | |
| B: Degree of sweetness | 0.8 | | | | | |
| (acesulfame K) | | | | | | |
| A/B | 12.8 | | | | | |
| Refreshing feeling | 2.8 | 3.6 | 3.6 | 3.6 | 3.4 | 3.4 |
| Sticky feeling | 3.4 | 2.4 | 2.0 | 2.0 | 2.4 | 2.4 |
| Aftertaste | 2.8 | 3.6 | 4.0 | 4.2 | 3.8 | 3.8 |
| Bitterness | 2.2 | 1.8 | 1.4 | 1.4 | 1.6 | 1.6 |
| Tastiness | 2.8 | 3.6 | 3.6 | 3.8 | 4.0 | 4.0 |
| Comprehensive evaluation | — | ◯ | ◯ | ◯ | ◯ | ◯ |

| | | Comparative | Comparative | Comparative | |
|---|---|---|---|---|---|
| | Example 6 | Example 2 | Example 3 | Example 4 | Example 7 |
| Malbit (% by mass) | 0 | 0 | 0 | 0 | 0.3 |
| ESWEE 30 (% by mass) | 0.3 | 0 | 0 | 0 | 0 |
| ESWEE 600 (% by mass) | 0 | 0.3 | 0 | 0 | 0 |
| Erythritol (% by mass) | 0 | 0 | 0.3 | 0 | 0 |
| SNF | 0.7 | 0.7 | 0.7 | 1.7 | 1.7 |
| Degree of sweetness | 16.6 | 16.6 | 16.6 | 16.5 | 16.8 |
| A: Degree of sweetness | 10.2 | | | | |
| (sucralose) | | | | | |
| B: Degree of sweetness | 0.8 | | | | |
| (acesulfame K) | | | | | |
| A/B | 12.8 | | | | |
| Refreshing feeling | 3.4 | 3.0 | 3.0 | 2.6 | 2.4 |
| Sticky feeling | 3.0 | 3.6 | 3.6 | 2.8 | 2.0 |
| Aftertaste | 2.8 | 2.6 | 2.6 | 3.2 | 3.6 |
| Bitterness | 2.0 | 2.2 | 2.4 | 2.4 | 2.4 |
| Tastiness | 3.8 | 3.4 | 3.2 | 3.6 | 3.8 |
| Comprehensive evaluation | ◯ | X | X | — | ◯ |

Comprehensive evaluation ◯: an improvement in the sticky feeling was observed in comparison with Comparative Example 1 or Comparative Example 4.
Comprehensive evaluation X: no improvement in sticky feeling is observed in comparison with Comparative Example 1 or Comparative Example 4.

TABLE 5

| | Comparative | | | Comparative | Comparative |
|---|---|---|---|---|---|
| | Example 5 | Example 8 | Example 9 | Example 6 | Example 7 |
| Malbit (% by mass) | 0 | 0.3 | 0 | 0 | 0 |
| ESWEE 30 (% by mass) | 0 | 0 | 0.3 | 0 | 0 |
| ESWEE 600 (% by mass) | 0 | 0 | 0 | 0.3 | 0 |
| Erythritol (% by mass) | 0 | 0 | 0 | 0 | 0.3 |
| SNF | 0 | 0 | 0 | 0 | 0 |
| Degree of sweetness | 9.8 | 10.0 | 10.0 | 10.0 | 10.0 |
| A: Degree of sweetness | 4.2 | | | | |
| (sucralose) | | | | | |
| B: Degree of sweetness | 0.4 | | | | |
| (acesulfame K) | | | | | |
| A/B | 10.5 | | | | |
| Refreshing feeling | 2.2 | 2.8 | 2.8 | 2.8 | 2.4 |
| Sticky feeling | 2.4 | 2.2 | 2.2 | 2.6 | 2.8 |
| Aftertaste | 3.2 | 3.6 | 3.2 | 2.8 | 2.8 |
| Bitterness | — | — | — | — | — |
| Tastiness | — | — | — | — | — |
| Comprehensive evaluation | — | ◯ | ◯ | X | X |

| | Comparative | Example | Comparative | Example |
|---|---|---|---|---|
| | Example 8 | 10 | Example 9 | 11 |
| Malbit (% by mass) | 0 | 0.3 | 0 | 0.3 |
| ESWEE 30 (% by mass) | 0 | 0 | 0 | 0 |
| ESWEE 600 (% by mass) | 0 | 0 | 0 | 0 |
| Erythritol (% by mass) | 0 | 0 | 0 | 0 |
| SNF | 0.7 | 0.7 | 0.7 | 0.7 |
| Degree of sweetness | 9.9 | 10.2 | 10.3 | 10.6 |
| A: Degree of sweetness | 4.2 | | 2.4 | |
| (sucralose) | | | | |
| B: Degree of sweetness | 0.4 | | 2.6 | |
| (acesulfame | | | | |
| A/B | 10.5 | | 0.9 | |
| Refreshing feeling | 2.4 | 3.6 | 2.6 | 3.0 |
| Sticky feeling | 3.4 | 2.4 | 3.2 | 3.0 |
| Aftertaste | 2.4 | 4.0 | 2.6 | 3.2 |
| Bitterness | 2.0 | 1.6 | 3.2 | 2.2 |
| Tastiness | 2.8 | 3.8 | 2.8 | 3.6 |
| Comprehensive evaluation | — | ◯ | — | ◯ |

Comprehensive evaluation ◯: an improvement in the sticky feeling was observed in comparison with Comparative Example 5, Comparative Example 8 or Comparative Example 9.
Comprehensive evaluation X: no improvement in sticky feeling is observed in comparison with with Comparative Example 5, Comparative Example 8 or Comparative Example 9.

From Comparative Example 1 and Examples 1 to 5, it can be appreciated that the sticky feeling can be suppressed when 0.1 to 2.0% by mass of the sugar alcohol having a degree of osmosis of less than 99 is contained and the refreshing feeling is further improved when 0.3 to 1.0% by mass of the sugar alcohol is further contained.

From Comparative Examples 1 to 3 and Example 6, it can be appreciated that the sticky feeling can be suppressed also when ESWEE30, which is a sugar alcohol having a degree of osmosis of less than 99, equivalent to that of Malbit, is used.

From Comparative Example 4 and Example 7, it can be appreciated that the sticky feeling can be suppressed by allowing the beverage to contain 0.1 to 2.0% by mass of the sugar alcohol having a degree of osmosis of less than 99 similarly, also when the content of the solids-not-fat (SNF) is 1.7, which is higher than that in Example 1.

From Comparative Examples 5 to 7 and Examples 8 to 9, it can be appreciated that the sticky feeling can be suppressed by allowing the beverage to contain 0.1 to 2.0% by mass of the sugar alcohol having a degree of osmosis of less than 99 similarly, also when no milk is contained.

From Examples 10 and 11, it can be appreciated that the sticky feeling is suppressed as well as the evaluation of bitterness becomes lower by allowing the beverage to contain sucralose and acesulfame potassium as the high-intensity sweetener and satisfying the relation A>B, wherein A is the degree of sweetness of sucralose contained in the beverage, and B is the degree of sweetness of acesulfame potassium contained in the beverage.

1. A beverage comprising:
a high-intensity sweetener; and
a sugar alcohol, wherein
the content of the sugar alcohol in the beverage is 0.1 to 2.0% by mass per beverage, and the degree of osmosis of the sugar alcohol contained in the beverage is less than 99.

2. The beverage according to claim 1, wherein
the beverage comprises sucralose and acesulfame potassium as the high-intensity sweetener, and
a relation: A>B is satisfied, wherein A is the degree of sweetness of sucralose contained in the beverage, and B is the degree of sweetness of acesulfame potassium contained in the beverage.

3. The beverage according to claim 1, wherein the degree of osmosis of the sugar alcohol is 70 or more and less than 99.

4. The beverage according to claim 1, wherein
the beverage comprises sucralose and acesulfame potassium as the high-intensity sweetener,
the content of sucralose is 0.005 to 0.02% by mass per beverage,
the content of acesulfame potassium is 0.001 to 0.01% by mass per beverage, and
the content ratio between sucralose and acesulfame potassium is 2:1 to 5:1.

5. A method of suppressing a sticky feeling in an aftertaste, comprising
adding a sugar alcohol in preparation of a beverage containing a high-intensity sweetener such that the content of the sugar alcohol in the beverage is 0.1 to 2.0% by mass, wherein
the degree of osmosis of the sugar alcohol contained in the beverage is less than 99.

6. The beverage according to claim 2, wherein the degree of osmosis of the sugar alcohol is 70 or more and less than 99.

7. The beverage according to claim 2, wherein
the beverage comprises sucralose and acesulfame potassium as the high-intensity sweetener,
the content of sucralose is 0.005 to 0.02% by mass per beverage,
the content of acesulfame potassium is 0.001 to 0.01% by mass per beverage, and
the content ratio between sucralose and acesulfame potassium is 2:1 to 5:1.

8. The beverage according to claim 3, wherein
the beverage comprises sucralose and acesulfame potassium as the high-intensity sweetener,
the content of sucralose is 0.005 to 0.02% by mass per beverage,
the content of acesulfame potassium is 0.001 to 0.01% by mass per beverage, and
the content ratio between sucralose and acesulfame potassium is 2:1 to 5:1.

9. The beverage according to claim 6, wherein
the beverage comprises sucralose and acesulfame potassium as the high-intensity sweetener,
the content of sucralose is 0.005 to 0.02% by mass per beverage,
the content of acesulfame potassium is 0.001 to 0.01% by mass per beverage, and
the content ratio between sucralose and acesulfame potassium is 2:1 to 5:1.
